(19) United States
(12) Patent Application Publication
(10) Pub. No.: US 2015/0028685 A1
(43) Pub. Date: Jan. 29, 2015

(54) COIL SHEET INCLUDING CORE AND CONTACTLESS POWER TRANSMISSION DEVICE INCLUDING THE SAME

(71) Applicant: SAMSUNG ELECTRO-MACHANICS CO., LTD., Suwon (KR)

(72) Inventors: Kang Ryong CHOI, Suwon (KR); Yong Il Kwon, Suwon (KR); Sung Yong An, Suwon (KR); Chang Ryul Jung, Suwon (KR)

(73) Assignee: SAMSUNG ELECTRO-MACHANICS CO., LTD., Suwon (KR)

(21) Appl. No.: 14/061,119

(22) Filed: Oct. 23, 2013

(30) Foreign Application Priority Data
Jul. 23, 2013 (KR) 10-2013-0086918

(51) Int. Cl. H01F 27/34; H01F 38/14

(52) U.S. Cl. CPC H01F 27/34; H01F 38/14
USPC 307/104; 336/221; 336/110

(57) ABSTRACT

There is provided a coil sheet including: a sheet having a spiral coil thereon; a core located at the central portion of the coil and having a thickness of t mm, wherein the core has a curvature in at least one of an upper surface of the core, a corner at which the upper surface and a side surface meet each other, and a position in which the core and the sheet meet each other.

### CROSS-REFERENCE TO RELATED APPLICATIONS

This application claims the priority of Korean Patent Application No. 10-2013-0086918 filed on Jul. 23, 2013, in the Korean Intellectual Property Office, the disclosure of which is incorporated herein by reference.

### BACKGROUND OF THE INVENTION

1. Field of the Invention

The present invention relates to a coil sheet including a core and a contactless power transmission device capable of perform wireless charging using electromagnetic induction.

2. Description of the Related Art

Recently, systems for wirelessly or contactlessly transmitting power in order to charge a secondary battery embedded in a mobile terminal or the like have been under development.

Typically, a contactless power transmission device includes a contactless power transmitter to transmit power and a contactless power receiver to receive and store power.

Such contactless power transmission devices transmit and receive power using electromagnetic induction. To this end, each of the contactless power transmitter and the contactless power receiver includes a coil therein.

The contactless power receiver including a circuit part and a coil part implements functions thereof while being situated in a cellular phone case or an additional cradle-like cell phone accessory.

The contactless power transmission device is operated in the following manner. Commercial alternating current (AC) power supplied from the outside is received by a power source unit of the contactless power transmitter.

The input commercial AC power is converted into direct current (DC) power by a power converting unit, is again converted into AC voltage having a particular frequency, and is then provided to the contactless power transmitter.

When the AC voltage is applied to the coil part of the contactless power transmitter, a magnetic field around the coil part is changed.

As the magnetic field of the coil part in the contactless power receiver disposed to be adjacent to the contactless power transmitter is changed, the coil part of the contactless power receiver outputs power to charge the secondary battery.

Charging efficiency increases with the magnetic field and is affected by the shape of the coils, the angle created by the coil in the contactless power receiver and the coil in the contactless power transmitter, and the like.

B=μ₀·n·i [Equation 1]

Normally, the strength of the magnetic field is increased in proportion to vacuum magnetic permeability (μ₀), turns (n) of a solenoid winding, and the amount of flowing current (i) as represented by Equation 1.

B=μ·μ₀·n·i [Equation 2]

If the coil has a permanent magnet at its center, the strength of the magnetic field is increased in proportion to vacuum magnetic permeability (μ₀), turns (n) of a solenoid winding, the amount of flowing current (i), and magnetic permeability (μ) of the permanent magnet as represented by Equation 2.

According to the related art, in order to allow the coil of the contactless power receiver and the contactless power transmitter to coincide with each other, the permanent magnet is positioned at a central portion of the coil of the contactless power receiver.

In this case, the strength of the magnetic field is affected by the magnetic permeability (μ) of the permanent magnet as represented by Equation 2. However, the magnetic permeability (μ) of the permanent magnet is so low that the strength of the magnetic field becomes weaker.

Therefore, efficiency of the contactless power transmission device is also decreased proportionally with the strength of the magnetic field becomes weaker due to the permanent magnet positioned at the central portion of the coil.

Further, the permanent magnet located in the center of the coil causes the magnetic field to pass through the shield layer of the contactless power receiver, thereby adversely affecting electronic devices.

Moreover, even if a soft magnetic core is located in the center of the coil to increase charging efficiency, a magnetic field passes through the receiving shield layer, thereby adversely affecting electronic devices.

Therefore, required is a technique that ensures high power transmission efficiency and minimizes influence of the magnetic field on electronic devices even in the case that the permanent magnet or soft magnetic core is used.

Patent Document 1 below is related to a wireless charging apparatus for mobile devices that determines whether a charging receiver is mounted using a magnetic for sensing in order to perform wireless power supplying.

However, Patent Document 1 does not relate to the shape of the permanent magnet, and does not disclose any solution for the issues discussed above.

### RELATED ART DOCUMENT

(Patent Document 1) Korean Patent Laid-open Publication No. 2012-0100217

### SUMMARY OF THE INVENTION

An aspect of the present invention provides a method of reducing the influence of a magnetic field on electronic devices byway of modifying the shape of a core located in the center of a spiral coil.

An aspect of the present invention also provides a method of increasing the efficiency of a contactless power transmission device while reducing the influence of a magnetic field on electronic devices.

According to an aspect of the present invention, there is provided coil sheet including: a sheet having a spiral coil thereon; a core located at the central portion of the coil and having a thickness of t mm, wherein the core has a curvature in at least one of an upper surface of the core, a corner at which the upper surface and a side surface meet each other, and a position in which the core and the sheet meet each other.

When a curvature of the upper surface of the core is referred to as c1, the curvature c1 of the upper surface of the core may be 0.2t/mm or greater.

When a curvature of the corner at which the upper surface and the side surface of the core meet each other is referred to as c2, the curvature c2 of the corner may be 0.2t/mm to 0.9 t/mm.

When a curvature of the position in which the core and the sheet meet each other is referred to as c3, the curvature c3 of the position may be 0.2t/mm to 2.95t/mm.

The thickness t of the core may be 0.01 mm to 5.00 mm.

The core may be a permanent magnet.

The permanent magnet may be formed of at least one selected from a group consisting of an Nd—Fe based magnet, an Sm2Co17 based magnet, a ferrite magnet and an alnico magnet.

The core may be formed of a soft magnetic material.

The soft magnetic material may be at least one selected from a group consisting of a Ni—Zn—Cu ferrite, a Mn—Zn ferrite, sandust, pure iron and moly permalloy powder (MPP).

According to another aspect of the present invention, there is provided a contactless power transmission device including: a coil sheet including a sheet having a spiral coil thereon and a core located at the central portion of the coil and having a thickness of t mm; and a power input unit applying a current to the coil, wherein the core has a curvature in at least one of an upper surface of the core, a corner at which the upper surface and a side surface meet each other, and a position in which the core and the sheet meet each other.

The device may further include a transmitting shield layer under the coil sheet. When a curvature of the upper surface of the core is referred to as c1, the curvature c1 of the upper surface of the core may be 0.2t/mm or greater.

When a curvature of the corner at which the upper surface and the side surface of the core meet each other is referred to as c2, the curvature c2 of the corner may be 0.2t/mm to 0.9 t/mm.

When a curvature of the position in which the core and the sheet meet each other is referred to as c3, the curvature c3 of the position may be 0.2t/mm to 2.95t/mm.

The thickness t of the core may be 0.01 mm to 5.00 mm.

The core may be formed of a permanent magnet or a soft magnetic material.

### BRIEF DESCRIPTION OF THE DRAWINGS

The patent or application file contains at least one drawing executed in color. Copies of this patent or patent application publication with color drawing (s) will be provided by the Office upon request and payment of the necessary fee.

The above and other aspects, features and other advantages of the present invention will be more clearly understood from the following detailed description taken in conjunction with the accompanying drawings, in which:

FIG. 1 is a perspective view schematically showing a coil sheet according to an embodiment of the present invention;

FIG. 2 is a cross-sectional view showing magnetic flux distribution without a core;

FIG. 3 is a cross-sectional view showing magnetic flux distribution with a core;

FIGS. 4 to 6 are cross-sectional views taken along line A-A′ of FIG. 1, in which the shape of a permanent magnet is schematically illustrated; and

FIG. 7 is an exploded perspective view schematically showing a contactless power transmitting device to another embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

In the specification, a curvature c refers to the degree to which a curved line or surface is bent. Curvature of a curved line is defined as a reciprocal of the radius r of an osculating circle to the curved line.

Hereinafter, embodiments of the present invention will be described in detail with reference to the accompanying drawings. In the descriptions, a contactless power transmission device collective refers to a contactless power transmitter to transmit power and a contactless power receiver to receive and store power.

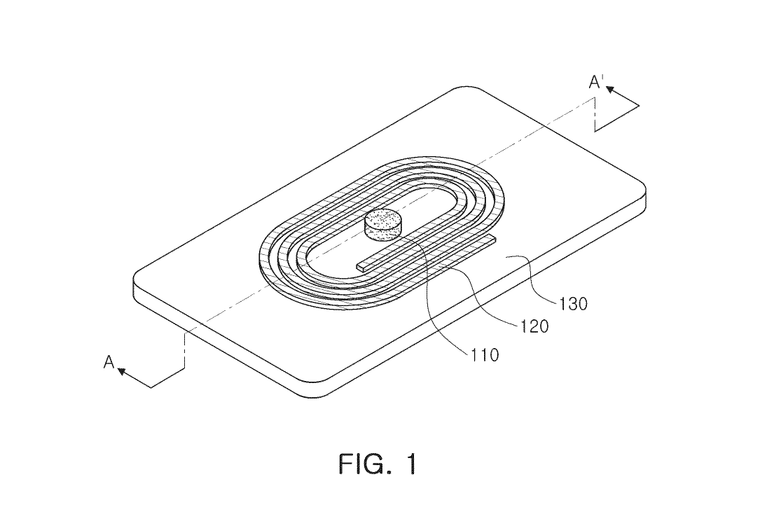

FIG. 1 is a perspective view schematically showing a coil sheet according to an embodiment of the present invention.

Referring to FIG. 1, the coil sheet according to the embodiment of the present invention includes a sheet 130 on which a spiral coil 120 is formed; and a core 110 which is located in the center of the coil 120 and has a thickness of t mm. The core 110 may be formed such that it has curvature in at least one of its upper surface, its corner at which the upper surface and side surface meet each other and a position in which the core and the sheet meet each other.

In an embodiment, the coil 120 may be formed on the sheet 130 as a wiring pattern such that one coil is connected thereto or a plurality of coil strips may be connected in parallel to form a coil pattern.

The coil 120 may be produced as a winding wire a flexible film, but is not limited thereto.

The coil 120 transmits input power using an induced magnetic field or receives the induced magnetic field to output power, thereby enabling contactless power transmission or local area communications.

In an embodiment, the core 110 may have a cylindrical or rectangular shape, but is not limited thereto.

The thickness t of the core 110 may be 0.01 mm to 5.00 mm.

If a core 110 having a thickness of 0.01 mm or greater is located at the center of the coil 120, it affects magnetic flux.

The core 110 may be formed of permanent magnet.

The permanent magnet refers to a magnet having a minute change in strength of residual magnetization even with magnetic disturbances from the outside.

The permanent magnet may be formed of at least one selected from a group consisting of an Nd—Fe based magnet, an Sm2Co17 based magnet, a ferrite magnet and an alnico magnet.

The permanent magnet 0 serves to align the center of the coil of the contactless power receiver with the center of the coil of the contactless power transmitter.

In addition, the core 110 may be formed of a soft magnetic material.

The soft magnetic material may be formed of at least one selected from a group consisting of a Ni—Zn—Cu ferrite, a Mn—Zn ferrite, sandust, pure iron and moly permalloy powder (MPP), but is not limited thereto.

In a case in which the core 110 is formed of the soft magnet material, magnetic flux may be strengthened when the magnetic field is generated from the coil 120.

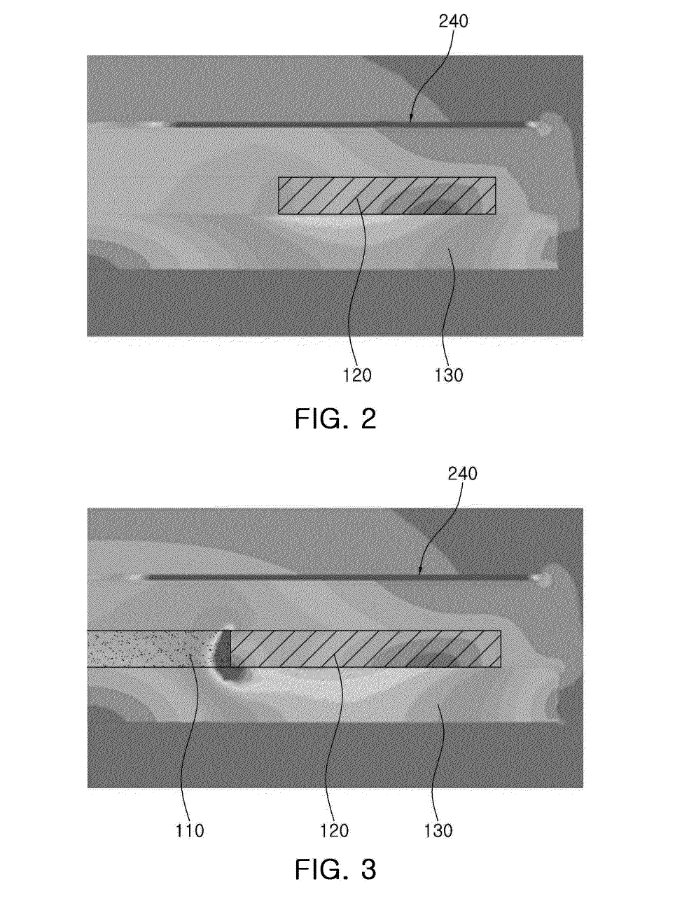

FIG. 2 is a cross-sectional view showing magnetic flux distribution without a core, and FIG. 3 is a cross-sectional view showing magnetic flux distribution with a core.

In FIGS. 2 and 3, the stronger the color is, the stronger the magnetic flux is.

As can be seen from FIGS. 2 and 3, the magnetic flux without a core does not penetrate the receiving shield layer 240, whereas the magnetic flux with the core penetrates the receiving shield layer 240.

That is, comparing FIG. 2 with FIG. 3, it can be seen that magnetic flux is further expanded beyond the receiving shield layer 240 in FIG. 3.

If the magnetic flux penetrates the receiving shield layer 240 of the receiver as described above, the magnetic flux affects on electronic devices, resulting in malfunction of the electronic devices.

In addition, as the magnetic flux penetrates the receiving shield layer 240, eventually magnetic flux leakage occurs, and thus the efficiency of the contactless power transmission device is lowered.

Comparing FIG. 2 with FIG. 3, it can be seen that magnetic flux is concentrated on the borders between the core 110 and the coil 120 or the sheet 130 in FIG. 3.

The concentrated magnetic flux is not used for generating induced magnetic field in the coil but is consumed as magnetic leakage flux.

Accordingly, when the magnetic field is concentrated as shown in FIG. 3, the efficiency of the contactless power transmission device is lowered due to magnetic flux leakage.

Table 1 below shows inductance L, magnetic flux T measured at the receiving shield layer 240, magnetic flux change T/ms penetrating the receiving shield layer 240 in Comparative Example 1 without a core and in Inventive Example 1 with a core formed of a permanent magnet.

TABLE 1

| | Comparative | Inventive |
|---|---|---|
| | Example 1 | Example 1 |
| Transmitting side inductance (uH) | 30.6 | 29.1 |
| Receiving side inductance (uH) | 21.8 | 20.4 |
| Receving shield layer maximum | 6.0 × 10⁻³ | 0.53 |
| magnetic flux (T) | | |
| Receiving shield layer | 0.10 | 0.14 |
| penetrating magnetic field | | |
| change (T/ms) | | |

As shown in Table 1, in a case in which a core is formed using a permanent magnet which is formed for aligning the centers of the coils in the contactless power transmitter and the contactless power receiver (Inventive Example 1), the permeability μ of the permanent magnet is low and thus the inductance at the transmitter is reduced.

Moreover, the maximum magnetic flux at the receiving shield layer and the magnetic flux penetrating the shield layer of the receiver is greatly changed due to the permanent magnet, thereby affecting adversely on electronic devices.

Therefore, in order to prevent the penetration of magnetic flux into the receiving shield layer 240 and to increase the efficiency of the contactless power transmission device, the core 110 according to an embodiment of the present invention may be formed such that it has curvature c at at least one of its upper surface, its corner at which the upper surface and side surface meet each other and a position in which the core 110 and the sheet 130 meet each other.

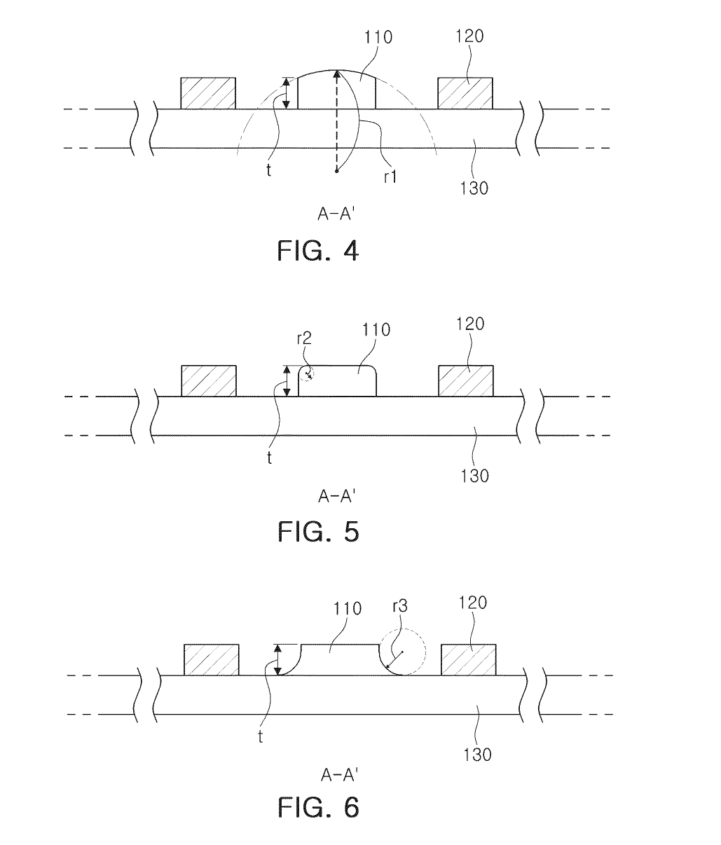

FIGS. 4 to 6 are cross-sectional views taken along line A-A′ of FIG. 1, in which a permanent magnet having a curvature c is schematically illustrated.

Referring to FIG. 4, it can be seen that the core 110 is formed to have a curvature c1 at its upper surface.

Curvature refers to the degree to which a curved line or surface is bent. The curvature c1 of the upper surface of the core 110 is defined as a reciprocal of the radius r1 of an osculating circle to the curve representing the upper surface in FIG. 4.

Referring to FIG. 5, it can be seen that the core 110 is formed to have a curvature c2 at corners at which its upper surface and side surfaces met.

The curvature c2 of the corner at which the upper surface of the core 110 and the side surfaces meet each other is defined as a reciprocal of the radius r2 of an osculating circle to the curve representing the corner in FIG. 4.

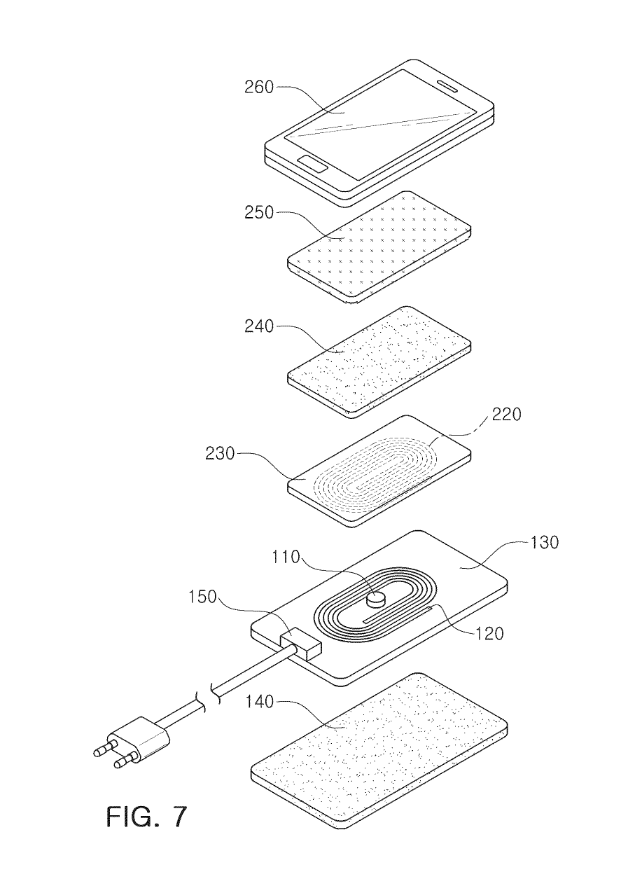

Referring to FIG. 6, it can be seen that the core 110 is formed to have a curvature c3 at positions at which the core 110 and the sheet 130 meet each other.

The curvature c3 of the positions at which the core 110 and the sheet meet each other is defined as a reciprocal of the radius r3 of an osculating circle to the curve representing the positions 130 in FIG. 6.

Table 2 below shows magnetic flux change T/ms penetrating the receiving shield layer and the efficiency of the contactless power transmission device % as the curvature c1 of the upper surface of the core 110 changes, when the core 110 is formed of a permanent magnet.

TABLE 2

| | Receiving shield | |
|---|---|---|
| | layer penetrating | Power |
| | magnetic field | transmission |
| Curvature (/mm) | change (T/ms) | efficiency (%) |
| 0 | X | X |
| 0.1t | X | X |
| 0.2t | ◯ | ◯ |
| 0.3t | ◯ | ◯ |
| 0.4t | ◯ | ◯ |
| 0.5t | ◯ | ◯ |
| 0.6t | ◯ | ◯ |
| 0.7t | ◯ | ◯ |
| 0.8t | ◯ | ◯ |
| 0.9t | ◯ | ◯ |
| 1.0t | ◯ | ◯ |

If the magnetic flux change T/ms penetrating the receiving shield layer exceeds 0.125 T/ms, eddy loss occurs. Therefore, if the magnetic flux change T/ms exceeded 0.125 T/ms, it is indicated by X, otherwise it is indicated by O.

The efficiency of the contactless power transmission device % represents the efficiency of the contactless power transmission device assuming that the efficiency of wired power transmission is 1.

If the efficiency % exceeded 65%, it is indicated by O, otherwise it is indicated by X.

As can be seen from Table 2, if the curvature c1 of the upper surface of the core 110 is 0.2 t/mm or greater, little magnetic flux penetrates the receiving shield layer 240 so that malfunctioning of electronic devices can be prevented. Further, the efficiency of the contactless power transmission device is ensured to be 65% or greater.

In other words, if the curvature c1 of the upper surface of the core 110 is below 0.2 t/mm, much magnetic flux penetrates the receiving shield layer 240 so that eddy loss occurs. Therefore, the efficiency of the contactless power transmission device is lowered and thus it is not commercially valuable.

The upper surface having the curvature c1 circularly protrudes even with the value of the curvature is significantly increased.

Accordingly, excluding when the curvature c1 of the upper surface is below 0.2 t/mm, if the curvature c1 of the upper surface is 0.2 t/mm or greater, little magnetic flux penetrates the receiving shield layer 240 so that malfunctioning of electronic devices can be prevented. Further, the efficiency of the contactless power transmission device is ensured to be 65% or greater.

Table 3 below shows magnetic flux change T/ms penetrating the receiving shield layer and the efficiency of the contactless power transmission device % as the curvature c2 of the corners at which the upper surfaces and side surfaces of the core 110 meet each other changes, when the core 110 is formed of a permanent magnet.

TABLE 3

| | Receiving shield | |
|---|---|---|
| | layer penetrating | Power |
| | magnetic field | transmission |
| Curvature (/mm) | change (T/ms) | efficiency (%) |
| 0 | X | X |
| 0.1t | X | ◯ |
| 0.2t | ◯ | ◯ |
| 0.3t | ◯ | ◯ |
| 0.4t | ◯ | ◯ |
| 0.5t | ◯ | ◯ |
| 0.6t | ◯ | ◯ |
| 0.7t | ◯ | ◯ |
| 0.8t | ◯ | ◯ |
| 0.9t | ◯ | ◯ |
| 1.0t | ◯ | X |

If the magnetic flux change T/ms penetrating the receiving shield layer exceeds 0.125 T/ms, eddy loss occurs. Therefore, if the magnetic flux change T/ms exceeded 0.125 T/ms, it is indicated by X, otherwise it is indicated by O.

The efficiency of the contactless power transmission device % represents the efficiency of the contactless power transmission device assuming that the efficiency of wired power transmission is 1.

If the efficiency % exceeded 65%, it is indicated by O, otherwise it is indicated by X.

As can be seen from Table 3, if the curvature c2 of the corners at which the upper surfaces and side surfaces of the core 110 meet each other is 0.2 t/mm to 0.9 t/mm, little magnetic flux penetrates the receiving shield layer 240 so that malfunctioning of electronic devices can be prevented. Further, the efficiency of the contactless power transmission device is ensured to be 65% or greater.

In other words, if the curvature c2 of the corners at which the upper surfaces and side surfaces of the core 110 meet each other is below 0.2 t/mm or above 0.9 t/mm, much magnetic flux penetrates the receiving shield layer 240. Therefore, the efficiency of the contactless power transmission device is lowered and thus it is not commercially valuable.

Table 4 below shows magnetic flux change T/ms penetrating the receiving shield layer and the efficiency of the contactless power transmission device % as the curvature c3 of the positions at which the core 110 and the sheet 130 meet each other changes, when the core 110 is formed of a permanent magnet.

TABLE 4

| | Receiving shield | |
|---|---|---|
| | layer penetrating | Power |
| | magnetic field | transmission |
| Curvature (/mm) | change (T/ms) | efficiency (%) |
| 0 | X | X |
| 0.1t | X | ◯ |
| 0.2t | ◯ | ◯ |
| 0.3t | ◯ | ◯ |
| 0.4t | ◯ | ◯ |
| 0.5t | ◯ | ◯ |
| 0.6t | ◯ | ◯ |
| 0.7t | ◯ | ◯ |
| 0.8t | ◯ | ◯ |
| 2.95t | ◯ | ◯ |
| 3.0t | ◯ | X |

If the magnetic flux change T/ms penetrating the receiving shield layer exceeds 0.125 T/ms, eddy loss occurs. Therefore, if the magnetic flux change T/ms exceeded 0.125 T/ms, it is indicated by X, otherwise it is indicated by O.

The efficiency of the contactless power transmission device % represents the efficiency of the contactless power transmission device assuming that the efficiency of wired power transmission is 1.

If the efficiency % exceeded 65%, it is indicated by O, otherwise it is indicated by X.

As can be seen from Table 4, if the curvature c3 of the positions at which the core 110 and the sheet 130 meet each other is equal to ore greater than 0.2 t/mm and lower than 2.95 t/mm, little magnetic flux penetrates the receiving shield layer 240 so that malfunctioning of electronic devices can be prevented. Further, the efficiency of the contactless power transmission device is ensured to be 65% or greater.

In other words, if the curvature c3 of the positions at which the core 110 and the sheet 130 meet each other is below 0.2 t/mm or above 2.95 t/mm, the efficiency of the contactless power transmission device is so lowered that it is not commercially valuable.

In addition, if the curvature c3 of the positions at which the core 110 and the sheet 130 meet each other is below 0.2 t/mm, the magnetic flux change T/ms penetrating the receiving shield layer exceeds 0.125 T/ms, such that eddy loss occurs.

Therefore, if the curvature c3 of the positions at which the core 110 and the sheet 130 meet each other is below 0.2 t/mm, the charging efficiency is also decreased, and malfunctioning of electronic devices may occur.

Thus, in order to ensure the charging efficiency and to obtain reliability by preventing malfunctioning of electronic devices, the curvature c3 of the positions at which the core 110 and the sheet 130 meet each other may be equal to or greater than 0.2 t/mm and lower than 2.95 t/mm.

FIG. 7 is an exploded perspective view schematically showing a contactless power transmitting device to another embodiment of the present invention.

Referring to FIG. 7, the contactless power transmitting device to the another embodiment of the present invention includes a coil sheet including a sheet 130 on which a spiral coil 120 is formed, and a core 110 which is located in the center of the coil 120 and has a thickness of t mm; and a power input unit 150 which supplies a current to the coil 120. The core 110 may be formed such that it has curvature in at least one of its upper surface, its corner at which the upper surface and side surface meet and a position in which the core 110 and the sheet 130 meet.

Commercial alternating current (AC) power supplied from the outside is received by the power input unit 150 of the contactless power transmission device.

The input commercial AC power is converted into direct current (DC) power by a power converting unit (not shown), is again converted into AC voltage having a particular frequency, and is then provided to the contactless power transmission device.

When the AC voltage is applied to the coil 120 of the contactless power transmission device, a magnetic field around the coil 120 is changed. And as the magnetic field of the coil 220 of the contactless power receiver disposed to be adjacent to the contactless power transmitter is changed, the coil 220 of the contactless power receiver outputs power.

A power storing unit 250 receives the power output from the coil 220 of the contactless power receiver, stores the power therein, and uses it when operating electronic devices 260 or the like.

The power storing unit 250 may be a lithium ion secondary battery.

The contactless power transmitter may include the power input unit 150.

The power input unit 150 may converts commercial AC power into DC power, converts the DC power into AC power having a particular frequency, and then transfers the AC power to the coil 120.

By applying the AC power having the particular frequency, an induced magnetic field is generated in the coil 120, such that the contactless power transmission device may be operated.

The contactless power transmission device may include a transmitting shield layer 140 under the sheet 130.

The transmitting shield layer 140 may prevent an induced magnetic field from being leaked to a rear surface during the operation of the contactless power transmission device, to increase the coverage of power transmission and the charging efficiency.

Further, a receiving shield layer 240 may be formed on the sheet 240 of the receiver of the contactless power transmission device.

The receiving shield layer 240 may prevent an induced magnetic field from being leaked to a rear surface during the operation of the contactless power transmission device, to increase the efficiency of power transmission and to prevent the magnetic flux from being leaked to cause malfunctioning in electronic devices 260.

The coil sheet and the contactless power transmission device according to the embodiments of the present invention described above are not limited to the above-mentioned embodiments, but may be variously applied.

In addition, although the contactless power transmission device employed in electronic devices has been described in the above-mentioned embodiments by way of example, the contactless power transmission device according to the present invention is not limited thereto but may be widely used in all kinds of chargeable electronic devices and all kinds of power transmission devices capable of transmitting power.

As set forth above, according to the embodiments of the present invention, curvature is formed in at least one of an upper surface of a core, a corner at which the upper surface and a side surface meet each other, and a position in which the core and a substrate meet each other.

Further, the efficiency of a contactless power transmission device can be increased by way of modifying the shape of a core in order to avoid concentrations of a magnetic field in particular regions.

While the present invention has been shown and described in connection with the embodiments, it will be apparent to those skilled in the art that modifications and variations can be made without departing from the spirit and scope of the invention as defined by the appended claims.

What is claimed is:

1. A coil sheet comprising:
a sheet having a spiral coil thereon;
a core located at the central portion of the coil and having a thickness of t mm,
wherein the core has a curvature in at least one of an upper surface of the core, a corner at which the upper surface and a side surface meet each other, and a position in which the core and the sheet meet each other.

2. The coil sheet of claim 1, wherein when a curvature of the upper surface of the core is referred to as c1, the curvature c1 of the upper surface of the core is 0.2t/mm or greater.

3. The coil sheet of claim 1, wherein when a curvature of the corner at which the upper surface and the side surface of the core meet each other is referred to as c2, the curvature c2 of the corner is 0.2t/mm to 0.9 t/mm.

4. The coil sheet of claim 1, wherein when a curvature of the position in which the core and the sheet meet each other is referred to as c3, the curvature c3 of the position is 0.2t/mm to 2.95t/mm.

5. The coil sheet of claim 1, wherein the thickness t of the core is 0.01 mm to 5.00 mm.

6. The coil sheet of claim 1, wherein the core is a permanent magnet.

7. The coil sheet of claim 6, wherein the permanent magnet is formed of at least one selected from a group consisting of an Nd—Fe based magnet, an Sm2Co17 based magnet, a ferrite magnet and an alnico magnet.

8. The coil sheet of claim 1, wherein the core is formed of a soft magnetic material.

9. The coil sheet of claim 8, wherein the soft magnetic material is at least one selected from a group consisting of a Ni—Zn—Cu ferrite, a Mn—Zn ferrite, sandust, pure iron and moly permalloy powder (MPP).

10. A contactless power transmission device comprising:
a coil sheet including a sheet having a spiral coil thereon and a core located at the central portion of the coil and having a thickness of t mm; and
a power input unit applying a current to the coil,
wherein the core has a curvature in at least one of an upper surface of the core, a corner at which the upper surface and a side surface meet each other, and a position in which the core and the sheet meet each other.

11. The device of claim 10, further comprising a receiving shield layer under the coil sheet.

12. The device of claim 10, wherein when a curvature of the upper surface of the core is referred to as c1, the curvature c1 of the upper surface of the core is 0.2t/mm or greater.

13. The device of claim 10, wherein when a curvature of the corner at which the upper surface and the side surface of the core meet each other is referred to as c2, the curvature c2 of the corner is 0.2t/mm to 0.9 t/mm.

14. The device of claim 10, wherein when a curvature of the position in which the core and the sheet meet each other is referred to as c3, the curvature c3 of the position is 0.2t mm to 2.95t/mm.

15. The device of claim 10, wherein the thickness t of the core is 0.01 mm to 5.00 mm.

16. The device of claim 10, the core is formed of a permanent magnet or a soft magnetic material.
